(19) United States
(12) Patent Application Publication
(10) Pub. No.: US 2015/0193024 A1
(43) Pub. Date: Jul. 9, 2015

(54) CAPACITIVE TOUCH CONTOL PEN

(71) Applicant: HUI-PIN LIANG, Changhua (TW)

(72) Inventors: SHANG-TUNG KAI, Changhua (TW); CHI-MING SUN, Changhua (TW)

(73) Assignee: HUI-PIN LIANG, Changhua (TW)

(21) Appl. No.: 14/222,589

(22) Filed: May 5, 2014

(30) Foreign Application Priority Data
Jan. 9, 2014 (TW) 103200636

(51) Int. Cl. G06F 3/0354; G06F 3/038

(52) U.S. Cl. CPC G06F 3/03545; G06F 3/0383

(57) ABSTRACT

A capacitive touch control pen is disclosed. The capacitive touch control pen includes a hollow conductive tube, having an open end and a closed end; a conductive touch control member, fastened at the open end of the conductive tube, one part of the conductive touch control member is exposed outside the conductive tube and the other part of the conductive touch control member is arranged inside the conductive tube; a circuit board, disposed at an inner wall of the conductive tube; and a conductive connection unit, electrically connected with the circuit board and the conductive tube to make the circuit board, the tube, the conductive connection unit, and the conductive touch control member become a circuit loop.

### FIELD OF THE INVENTION

The present invention relates to touch control, and more particularly to a capacitive touch control pen.

### BACKGROUND OF THE INVENTION

Because electronic industries grow rapidly, the new productions of the 3C applications are more and newer, especially for the touch-controlled operation interface.

Basically, touch-controlled operation interface is performed by the combination of the touch panel and the graphical operation interface of the operation system. The touch panel may be resistive touch panel, capacitive touch panel, optical touch panel, electromagnetic touch panel, or surface acoustic wave touch panel. In early periods, PDA or mobile phone is mainly used the resistive touch panel. The resistive touch panel may detect the signal(s) with being force strengths on the resistive touch panel by a touch control pen while operating. The stylus of this kind of touch control pen is thinner and hard, so it is easy to damage the surface of the resistive touch panel and hard to perform multi-touch functions.

Recently, many technology companies develops different mobile phones and tablet PCs which are manly used capacitive touch panel, capable of supporting multi-touch functions, and may combine smoothly graphical operation interface. It has been getting a large response from consumers and leading the 3C products to use capacitive touch panel. Generally, the capacitive touch panels are operated by users' finger(s). But the touch control pen is more convenient than the finger(s). And the touch control pen used for traditionally resistive touch panel may be not directly used for the capacitive touch panel.

The structure of the conventional capacitive touch control pen is much more complicated, heavy weight, and hard to be carried for use.

### SUMMARY OF THE INVENTION

An objective of this invention is providing a capacitive touch control pen. It is having simplified structure, light weight, and convenient to be carried for use.

To achieve above objectives, a capacitive touch control pen is provided. The capacitive touch control pen includes a hollow conductive tube, having an open end and a closed end; a conductive touch control member, fastened at the open end of the conductive tube, one part of the conductive touch control member is exposed outside the conductive tube and the other part of the conductive touch control member is arranged inside the conductive tube; a circuit board, disposed at an inner wall of the conductive tube; and a conductive connection unit, electrically connected with the circuit board and the conductive tube to make the circuit board, the tube, the conductive connection unit, and the conductive touch control member become a circuit loop.

The conductive touch control pen may further comprise a battery module. The battery module may be disposed inside the conductive tube and located adjacent to the closed end of the conductive tube. The circuit board is electrically connected to a first electrode of the battery module and a second electrode of the battery module is connected to the conductive tube via the conductive connection unit to make the circuit board, the tube, the conductive connection unit, the conductive touch control member, and the battery module become the circuit loop.

In some embodiments, the conductive connection unit is a metal rivet or elastic plate.

To achieve above objectives, one another capacitive touch control pen is provided. The capacitive touch control pen includes a hollow tube, made by non-conductive materials and having an open end and a closed end, a conductive layer is coated outside the tube and a conductive plate is arranged at a predetermined position inside the tube; a conductive touch control member, fastened at the open end of the tube and electrically contacted with the conductive layer, one part of the conductive touch control member is exposed outside the tube and the other part of the conductive touch control member is arranged inside the tube; a circuit board, disposed at an inner wall of the tube; a conductive connection unit, electrically connected with the circuit board and the conductive plate; and a battery module, disposed inside the tube and located adjacent to the closed end of the tube, the circuit board is electrically connected to a first electrode of the battery module and a second electrode of the battery module is connected with the conductive layer and the conductive plate to make the circuit board, the conductive layer and the conductive plate of the non-conductive tube, the conductive connection unit, the conductive touch control member, and the battery module become the circuit loop.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 is a structural view of a capacitive touch control pen according to this present invention.

FIG. 2 is a view of a first embodiment of the capacitive touch control pen according to this present invention.

FIG. 3 is a view of a second embodiment of the capacitive touch control pen according to this present invention.

FIG. 4 is a view of a third embodiment of the capacitive touch control pen according to this present invention.

FIG. 5 is a view of a fourth embodiment of the capacitive touch control pen according to this present invention.

### DESCRIPTION OF THE PREFERRED EMBODIMENT

Referring now to the drawings where like characteristics and features among the various figures are denoted by like reference characters.

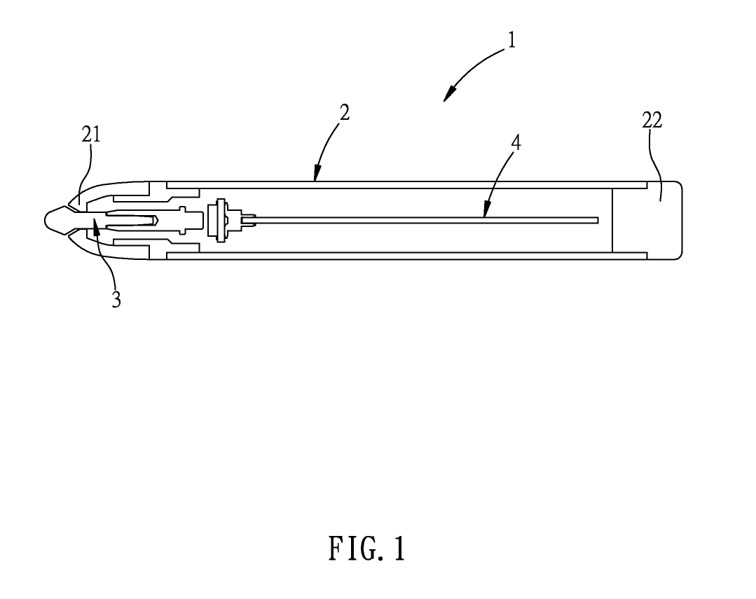

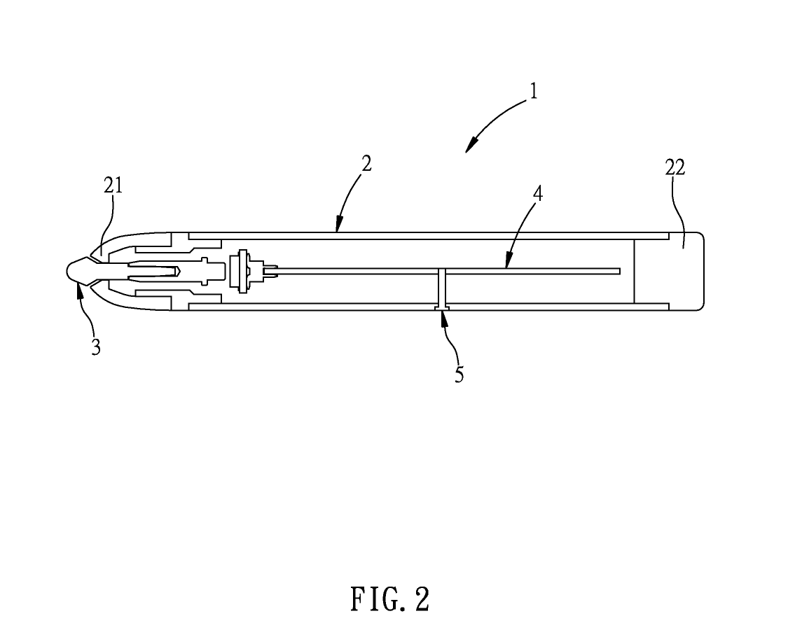

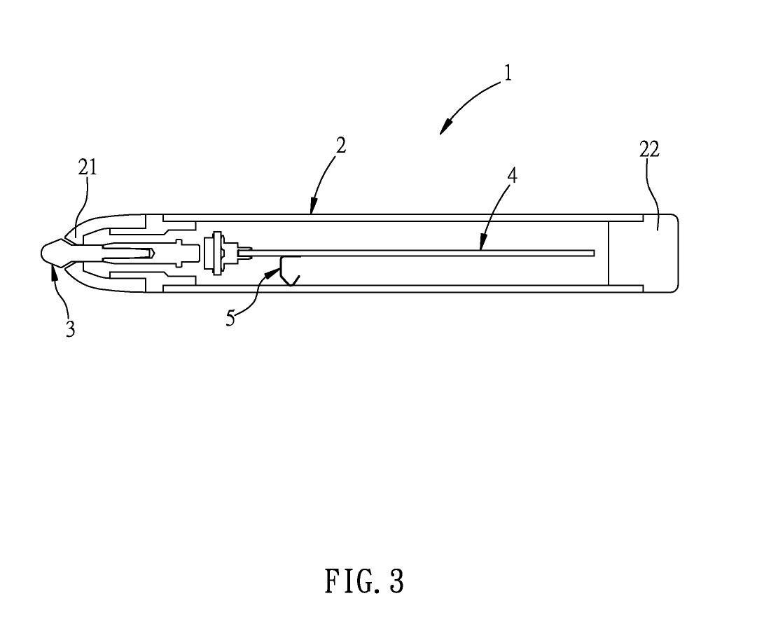

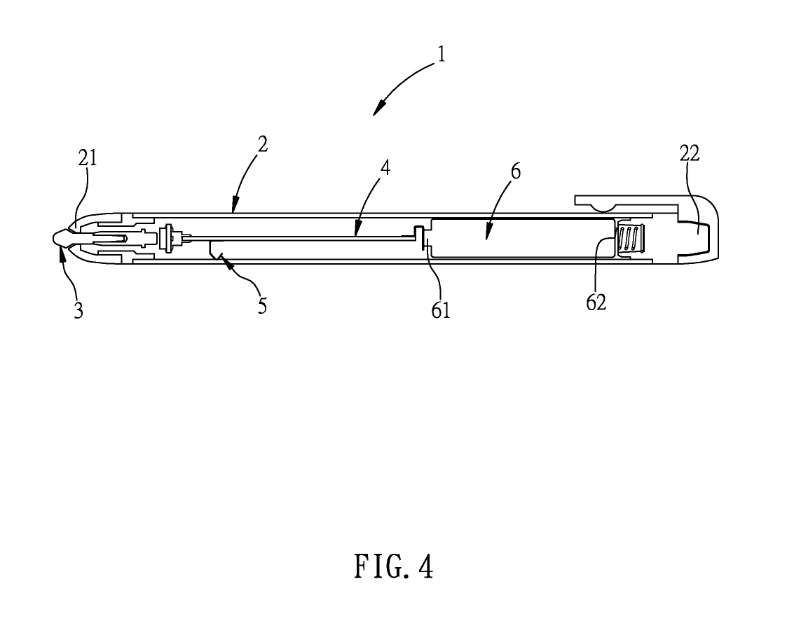

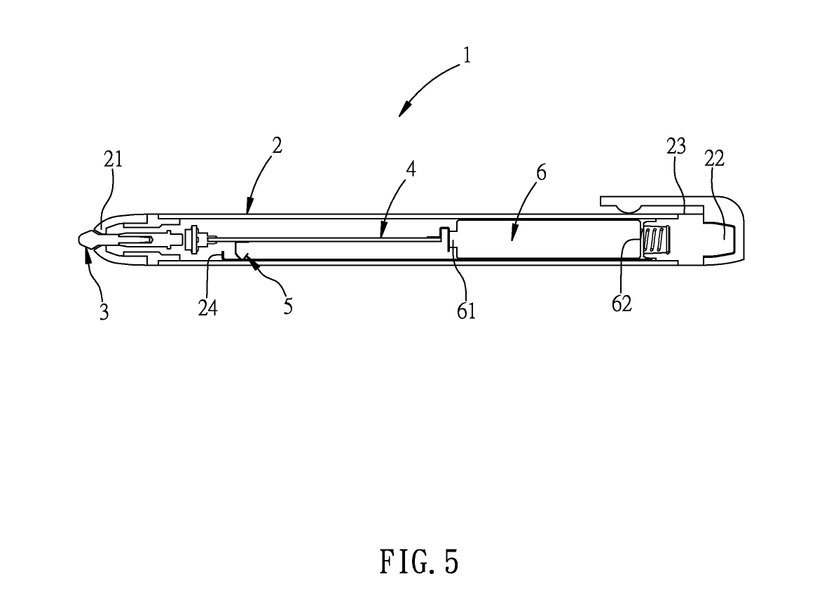

FIG. 1 is a structural view of a capacitive touch control pen according to this present invention. FIG. 2 is a view of a first embodiment of the capacitive touch control pen according to this present invention. FIG. 3 is a view of a second embodiment of the capacitive touch control pen according to this present invention. FIG. 4 is a view of a third embodiment of the capacitive touch control pen according to this present invention. FIG. 5 is a view of a fourth embodiment of the capacitive touch control pen according to this present invention.

Please refer to FIGS. 1 to 5, the capacitive touch control pen 1 of this invention may comprise a tube 2, a conductive touch control member 3, a circuit board 4, and a conductive connection unit 5.

The tube 2 is hollow and conductive. Also, the conductive tube 2 has an open end 21 and a closed end 22.

The conductive touch control member 3 may be fastened at the open end 21 of the conductive tube 2 made by conductive materials. One part of the conductive touch control member 3 is exposed outside the conductive tube 2, and the other part of the conductive touch control member 3 is arranged inside the conductive tube 2.

The circuit board 4 may be disposed at an inner wall of the conductive tube 2.

The conductive connection unit 5 may be electrically connected with the circuit board 4 and the conductive tube 2 to disposed inside the conductive tube 2 and located adjacent to the closed end 22 of the conductive tube 2, the circuit board 4 is electrically connected to a first electrode 61 of the battery module 6 and a second electrode 62 of the battery module 6 is connected to the conductive tube 2 via the conductive connection unit 5 to make the circuit board 4, the tube 2, the conductive connection unit 5, and the conductive touch control member 3 become the circuit loop. For example, the conductive connection unit 5 may be a metal rivet (shown as FIG. 2) or elastic plate (shown as FIG. 3), but not limited thereto.

The conductive touch control pen 1 may further comprise a battery module 6. The battery module 6 may be disposed inside the conductive tube 2 and located adjacent to the closed end 22 of the conductive tube 2. The circuit board 4 may be electrically connected to a first electrode (such as an anode) 61 of the battery module 6 and a second electrode (such as a cathode) 62 of the battery module 6 is connected to the conductive tube 2 via the conductive connection unit 5 to make the circuit board 4, the conductive tube 2, the conductive connection unit 5, the conductive touch control member 3, and the batter module 6 become the circuit loop.

Besides, the tube 2 may be made by non-conductive materials and have the open end 21 and the closed end 22. A conductive layer 23 is coated outside the non-conductive tube 2 and a conductive plate 24 is arranged at a predetermined position inside the non-conductive tube 2 (shown as in FIG. 5).

The conductive connection unit 5 may be electrically connected with the circuit board 4 and the conductive plate 24.

The battery module 6 may be disposed inside the non-conductive tube 2 and located adjacent to the closed end 22 of the non-conductive tube 2. The circuit board 4 is electrically connected to the first electrode (such as an anode) 61 of the battery module 6 and a second electrode (such as a cathode) 62 of the battery module 6 is connected with the conductive layer 23 and he conductive plate 24 to make the circuit board 4, the conductive layer 23 and the conductive plate 24 of the non-conductive tube 2, the conductive connection unit 5, the conductive touch control member 3, and the battery module 6 become the circuit loop.

Therefore, the above mentioned capacitive touch control pen 1 is having simplified structure, light weight, and convenient to be carried for use.

What is claimed is:

1. A capacitive touch control pen, comprising:
a hollow conductive tube, having an open end and a closed end;
a conductive touch control member, fastened at the open end of the conductive tube, one part of the conductive touch control member is exposed outside the conductive tube and the other part of the conductive touch control member is arranged inside the conductive tube;
a circuit board, disposed at an inner wall of the conductive tube; and
a conductive connection unit, electrically connected with the circuit board and the conductive tube to make the circuit board, the tube, the conductive connection unit, and the conductive touch control member become a circuit loop.

2. The conductive touch control pen as claimed in claim 1, wherein the conductive connection unit is a metal rivet or elastic plate.

3. The conductive touch control pen as claimed in claim 1, further comprising a battery module, the battery module is disposed inside the conductive tube and located adjacent to the closed end of the conductive tube, the circuit board is electrically connected to a first electrode of the battery module and a second electrode of the battery module is connected to the conductive tube via the conductive connection unit to make the circuit board, the tube, the conductive connection unit, the conductive touch control member, and the battery module become the circuit loop.

4. A capacitive touch control pen, comprising:
a hollow tube, made by non-conductive materials and having an open end and a closed end, a conductive layer is coated outside the tube and a conductive plate is arranged at a predetermined position inside the tube;
a conductive touch control member, fastened at the open end of the tube and electrically contacted with the conductive layer, one part of the conductive touch control member is exposed outside the tube and the other part of the conductive touch control member is arranged inside the tube;
a circuit board, disposed at an inner wall of the tube;
a conductive connection unit, electrically connected with the circuit board and the conductive plate; and
a battery module, disposed inside the tube and located adjacent to the closed end of the tube, the circuit board is electrically connected to a first electrode of the battery module and a second electrode of the battery module is connected with the conductive layer and the conductive plate to make the circuit board, the conductive layer and the conductive plate of the non-conductive tube, the conductive connection unit, the conductive touch control member, and the battery module become the circuit loop.

5. The conductive touch control pen as claimed in claim 4, wherein the conductive connection unit is a metal rivet or elastic plate.
